(19) United States
(12) Patent Application Publication
(10) Pub. No.: US 2010/0206669 A1
(43) Pub. Date: Aug. 19, 2010

(54) ELEVATOR

(75) Inventors: Yuki Matsuzawa, Tokyo (JP); Tomoki Iijima, Tokyo (JP)

Correspondence Address: FOLEY AND LARDNER LLP;SUITE 500, 3000 K STREET NW, WASHINGTON, DC, 20007, US

(73) Assignee: TOSHIBA ELEVATOR KABUSHIKI KAISHA

(21) Appl. No.: 12/704,977

(22) Filed: Feb. 12, 2010

(30) Foreign Application Priority Data
Feb. 13, 2009 (JP) 2009-030877

(51) Int. Cl. B66B 11/08; B66B 7/02; B66B 7/06; B66B 11/04

(52) U.S. Cl. 187/266

(57) ABSTRACT

An elevator has a car, a balance weight, a traction sheave, a driving unit, deflector sheaves and main ropes. The balance weight moves in a back region. The traction sheave has a rotational plane disposed in parallel with a back wall in the back region of the uppermost portion of the elevator shaft. The deflector sheaves have rotational planes disposed in parallel with a lateral inner wall of the elevator shaft in a side region. The driving unit is installed on the rotation center line of the traction sheave, and at least a part of the driving unit is disposed in the side region. The direction of the winding plane of the plurality of main ropes is changed between the traction sheave and the deflector sheave.

### CROSS-REFERENCE TO RELATED APPLICATIONS

This application is based upon and claims the benefit of priority from prior Japanese Patent Application No. 2009-030877, filed Feb. 13, 2009, the entire contents of which are incorporated herein by reference.

### BACKGROUND OF THE INVENTION

1. Field of the Invention

The present invention relates to an elevator in which a traction machine is disposed in an elevator shaft.

2. Description of the Related Art

There is an elevator in which a traction machine is disposed in an elevator shaft, whereby any independent machine room is not provided on the elevator shaft. In this type of elevator, the traction machine is often disposed in the upper part of the elevator shaft.

Jpn. Pat. Appln. KOKAI Publication No. 2001-080843 discloses an elevator including a traction machine disposed at a position overlapping with a car on a horizontal projection plane. The traction machine has a traction sheave in which a rotation shaft is horizontally held and around which main ropes are wound. The lower surface of this traction machine is installed at a position higher than the most rising position of the car and a counterweight, and hence the traction machine is disposed at the upper end of a rail.

This elevator has a movement path of the counterweight between the backside wall on the inner side from the entrance of the car and the inner wall of the elevator shaft. Moreover, a driving shaft of the traction machine is disposed aslant relative to the side wall of the car in order to increase the ratio of the floor area of the car with respect to the horizontal cross section of the elevator shaft.

International Publication No. WO 02/18256 discloses an elevator in which the body of a traction machine is disposed to overlap with the inner corner portion of a car on a horizontal projection plane. A counterweight is disposed at the rear of the car. The traction machine is installed so that the rotation shaft of a traction sheave extends aslant relative to such a direction as to pass through the entrance of the car. First and second deflector sheaves for guiding main ropes from the traction sheave to the car are disposed with a space being left therebetween in a horizontal direction in the upper part of an elevator shaft.

International Publication No. WO 01/62654 discloses an elevator in which a part of a traction machine is disposed in a region overlapping with a car on a horizontal projection plane. The car of this elevator has a handrail for acquiring a work area for a worker on the top. As the traction machine of this elevator, a thin motor having a small dimension in the rotation shaft direction of a traction sheave. As the rotational planes of the traction machine and traction sheaves are disposed in parallel with the side wall of the car when a balance weight is disposed between the side area of the car and an elevator shaft, a large work area surrounded by the handrail is acquired.

However, in a case where the balance weight is disposed between the rear wall of the car and the elevator shaft, the traction machine is disposed near the top of the elevator shaft so that the axis of a motor shaft of the traction machine is directed aslant relative to such a direction as to pass through the entrance of the car. If the work area surrounded by the handrail is installed over the full breadth of the upper part of the car, the bottom part of the traction machine interferes with the upper end of the handrail when the car rises to its uppermost position. Therefore the work area surrounded by the handrail is limited to avoid the interference of the handrail with the traction machine. Moreover, main ropes extending under the car are also disposed aslant relative to the entrance of the car. Therefore, main ropes are forced to extend as roping involving torsion among the traction sheave and the sheave of the balance weight and an under-car sheave.

### BRIEF SUMMARY OF THE INVENTION

According to the present invention, there is provided an elevator in which a traction machine is installed in an elevator shaft and in which a large work area surrounded by a handrail is secured.

According to one embodiment of the invention, an elevator comprises a car, a balance weight, a traction sheave, a driving unit, deflector sheaves and main ropes. The car moves in an elevator shaft. The balance weight moves in a back region between a back wall of the car and a rear inside wall of the elevator shaft. The traction sheave has a rotational plane arranged in parallel with the back wall of the car in the back region of the uppermost portion of the elevator shaft. The deflector sheaves have rotational planes arranged in parallel with a lateral inner wall of the elevator shaft in a side region between one side wall of the car and the lateral inner wall of the elevator shaft corresponding to the side wall of the car. The driving unit is settled on the rotation center line of the traction sheave to drive the traction sheave, and has at least a part thereof disposed in the side region. The main ropes are passed under the car and changed the direction of a winding plane of the main ropes between at least the traction sheave and the deflector sheave.

The “front wall” is a wall in which an entrance of the car is installed. The “back wall” is the wall of the car on the inner side from the entrance of the car. The “side wall” is the wall of the car on the right or left side of the entrance. The “rear inside wall” is the inside wall of the elevator shaft on the inner side from the entrance. The “lateral inside wall” is the inside wall of the elevator shaft on the right or left side of the entrance. The “back region” and the “side region” include not only a region where the car moves but also a region extending upwardly from the movement region. The “winding plane” is a plane along which the main ropes wound around the sheaves. The “rotational plane” is a plane along which the sheaves rotate.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an elevator according to one embodiment of the present invention;

FIG. 2 is a plan view of the elevator shown in FIG. 1;

FIG. 3A is a front view of a driving unit and its peripheral shown in FIG. 2 as seen from an elevator hall;

FIG. 3B is a front view of the driving unit and its peripheral shown in FIG. 2 as seen from the elevator hall when a car is raised to an uppermost;

FIG. 4 is a side view between a traction machine and under-car sheaves of a car shown in FIG. 1 as seen from the center of an elevator shaft;

FIG. 5 is a development of roping of main ropes in the elevator shown in FIG. 1;

FIG. 6 is a side view of a first modification in which the arrangement of deflector sheaves varies as compared with FIG. 4;

FIG. 7 is a side view of a second modification in which the arrangement of deflector sheaves varies as compared with FIG. 4;

FIG. 8 is a side view of a third modification in which fastening mounts of deflector sheaves vary as compared with FIG. 7;

FIG. 9 is a side view of a fourth modification in which fastening mounts of deflector sheaves vary as compared with FIG. 7; and

FIG. 10 is a side view of a fifth modification in which fastening mounts of deflector sheaves vary as compared with FIG. 9.

### DETAILED DESCRIPTION OF THE EMBODIMENTS

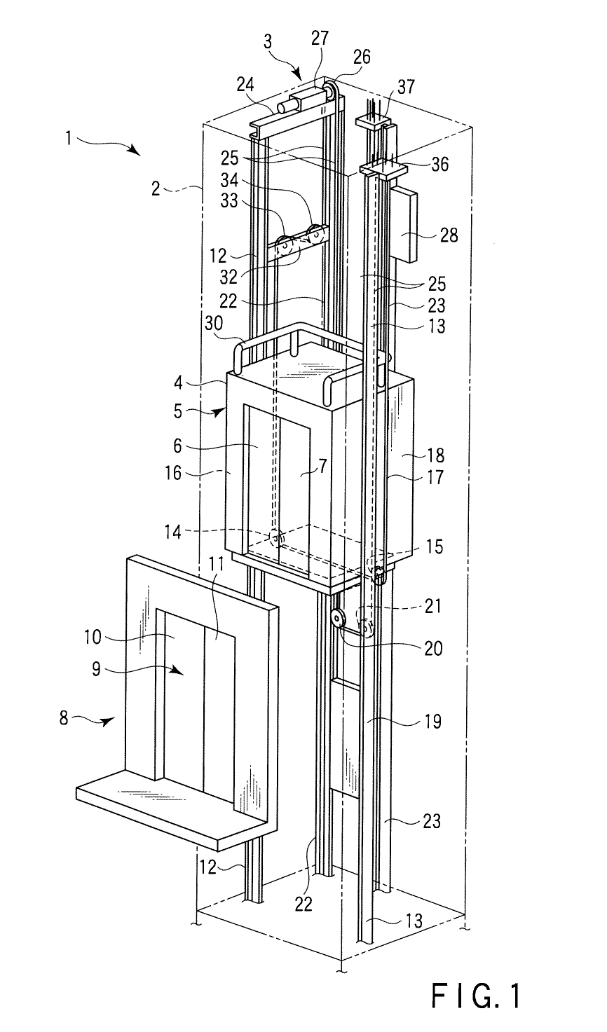

An elevator 1 of one embodiment of the present invention will be described with reference to FIGS. 1 to 10. In the drawings, the same constitution is denoted with the same reference numeral, and redundant description is omitted. In the description, for the sake of the convenience of the description of each constitution, “upper” and “lower” along a vertical direction in which a gravity acts, “front” on an entrance of a car, “rear” or “back” on the inner side from the entrance, and “left” and “right” seen from the entrance of the car are mentioned sometimes.

The elevator 1 has a traction machine 3 disposed in the uppermost of an elevator shaft 2, and no machine room is disposed. Therefore the elevator 1 is called “machine-room-less elevator”. The elevator 1 comprises a car 4, a balance weight 19, a traction sheave 26, deflector sheaves 33, 34, a driving unit 27 and main ropes 25. The traction machine 3 is constituted of the traction sheave 26 and the driving unit 27. The car 4 has an entrance in a front wall 5, and comprises car doors 6, 7 for closing this entrance. The car doors 6, 7 face hall doors 10, 11 which close an entrance 9 in an elevator hall 8, when the car 4 reaches any floor. The car 4 is guided along a pair of car guide rails 12, 13 on the right and left sides to move in the elevator shaft 2.

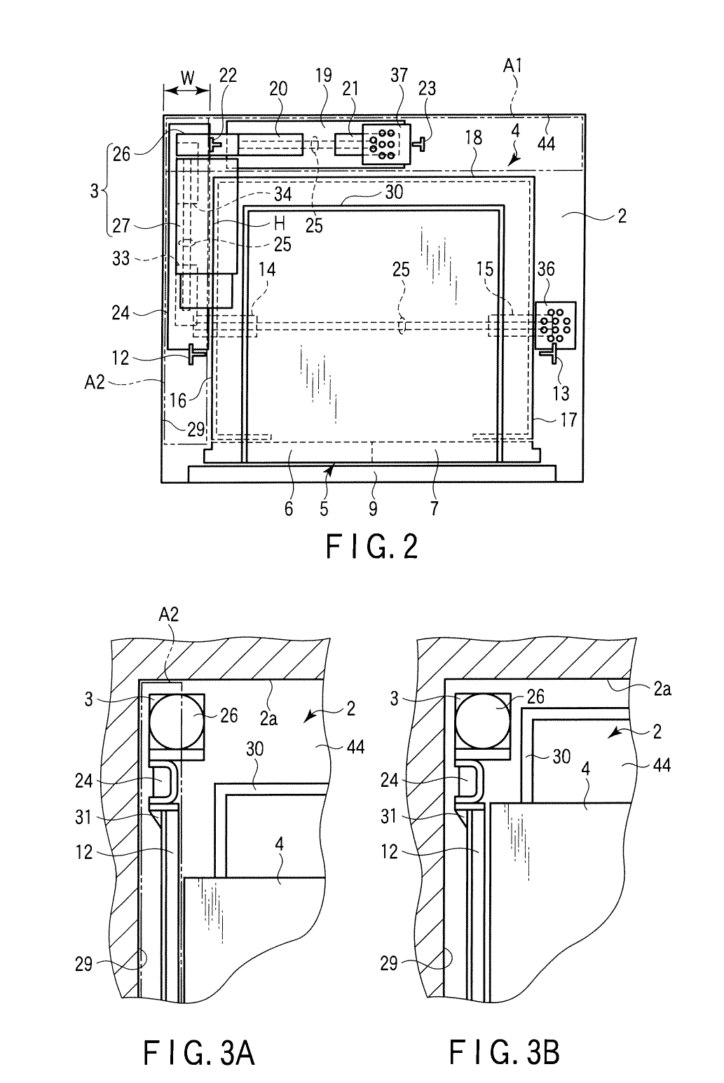

The car 4 comprises a pair of left and right under-car sheaves 14, 15 in a bottom. The under-car sheaves 14, 15 are supported by a sheave support member. As shown in FIG. 2, the under-car sheaves 14, have rotational planes arranged in parallel with the car doors 6, 7 of the car 4. That is, the under-car sheaves 14, 15 freely rotate around a shaft extending horizontally in such direction as to pass through the entrance of the car 4. The under-car sheaves 14,15 have an rotational planes arranged aslant relative to the front wall 5 and the car doors 6,7 if the main ropes 25 are passed aslant relative to the front wall 5 and under the car 4.

The car 4 comprises guide units corresponding to the car guide rails 12, 13 in upper and lower portions thereof outside a left side wall 16 and a right side wall 17, respectively. The guide units are, for example, guide shoes or guide rollers. When the guide units are the guide shoes, the guide units slide with respect to the car guide rails 12, 13. When the guide units are the guide rollers, the guide units roll with respect to the car guide rails 12, 13. In consequence, the car 4 smoothly moves upwardly or downwardly in the elevator shaft 2.

As shown in FIG. 2, the balance weight 19 is disposed in a back region between a back wall 18 on the inner from the entrance of the car 4 and a rear inside wall 44 of the elevator shaft 2 facing this back wall 18. Here, “the back region” is a gap formed from the top of the elevator shaft 2 to the bottom thereof between the rear inside wall 44 of the elevator shaft 2 and a plane along the back wall 18 of the car 4 in the elevator shaft 2, when the elevator shaft 2 is seen from the upside in the vertical direction, and the back region is not limited to a region right behind a region where the car 4 moves. The balance weight 19 has weight sheaves 20, 21 on a top. The weight sheaves 20, 21 have rotational planes arranged in parallel with the back wall 18. That is, the weight sheaves 20, 21 freely rotate around the shaft extending horizontally in such a direction as to pass through the entrance of the car 4. The balance weight 19 is guided by a pair of weight guide rails 22, 23 disposed on the left and right sides, to rise and lower in the elevator shaft 2.

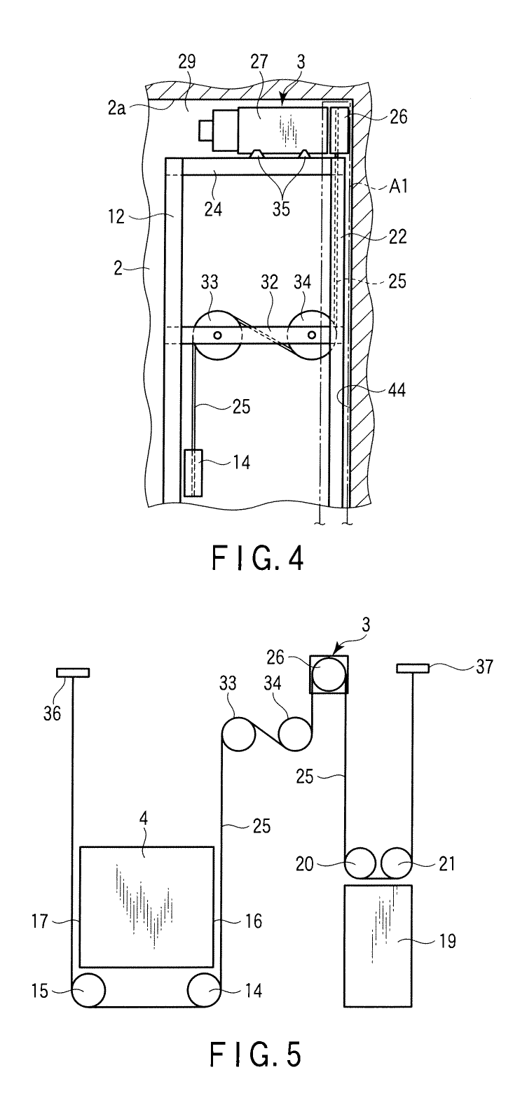

A support beam 24 is horizontally bridged over the upper ends of the car guide rail 12 and the weight guide rail 22 as shown in FIGS. 1 and 4. The traction machine 3 is settled and supported on the upper surface of the support beam 24. The traction machine 3 has the traction sheave 26, the driving unit 27 and a base 35 as shown in FIG. 4.

The traction sheave 26 has a rotational plane arranged in parallel with the back wall 18 of the car 4 in the uppermost of the elevator shaft 2 in a back region A1 between the back wall 18 of the car 4 and the rear inside wall 44 of the elevator shaft 2 as shown in FIG. 2. A plurality of main ropes 25 made of steel wires are wound around the traction sheave 26.

The driving unit 27 is prepared for driving the traction sheave 26, has an output shaft connected to the traction sheave 26, and is installed on the rotation center axis of the traction sheave 26. In the present embodiment, as shown in FIG. 1, a long shaft motor prolonged along the center line of the output shaft is used as the driving unit 27. The long shaft motor has a dimension along the center line of the output shaft which is larger than that along the radius of the output shaft.

The base 35 is fastened to the support beam 24, and receives the driving unit 27. The support beam 24 supports the load of an elevator device including the car 4 with an onboard object and the balance weight 19, the car and the balance weight are suspended by the main ropes 25. As shown in FIG. 1, a control unit 28 which controls the operation of the car 4 is attached to the weight guide rail 23. The traction machine 3 transmits or receives a command signal for rotation driving or a signal for control to or from the control unit 28. The control unit 28 includes a CPU, an ROM, an RAM and the like.

FIG. 2 is a plan view of the elevator 1 of FIG. 1. In FIG. 2, the downside in the drawing is a front wall 5 side of the car 4, and the upside in the drawing is a back wall 18 side of the car 4. In FIG. 2, elements denoted with the same reference numerals as those in FIG. 1 are the same elements as those of FIG. 1. The driving unit 27 is provided to rotate the traction sheave 26 around the center line of the rotation shaft horizontally extending in parallel with the side wall 16 of the car 4.

The support beam 24 is bridged between the upper end of the car guide rail 12 provided in a side region A2 and the upper end of the weight guide rail 22 provided close to the side region A2 in the side region A2 between the left side wall 16 of the car 4 and a lateral inside wall 29 of the elevator shaft 2 corresponding to this left side wall. Therefore, the projected area of the support beam 24 does not overlap with that of the car 4, when the elevator shaft 2 is seen from the upside in the vertical direction. That is, the width of the support beam 24 along the front wall 5 of the car 4 is smaller than a gap W determined by the left side wall 16 of the car 4 and the left lateral inside wall 29 of the elevator shaft 2. However, the traction machine 3 is disposed so that a part of the projected area of the traction machine 3 overlaps with the projected area of the car 4, when the elevator shaft 2 is seen from the upside in the vertical direction.

As shown in FIGS. 1 and 2, a handrail 30 is provided on the car 4 to acquire a work area where a worker safely works on the car 4. The handrail 30 is provided so that the work area surrounded by the handrail 30 does not overlap with the projected area of the traction machine 3 in the plane of the elevator shaft 2 projected in the vertical direction.

FIGS. 3A and 3B are a front view of the periphery of the support beam 24 in a case where the elevator shaft 2 side is seen from the front of the car 4, that is, from the elevator hall 8. The support beam 24 is formed by combining a standard steel material. The longitudinal direction of the support beam 24 extends horizontally along the side wall 16 of the car 4. The support beam 24 is bridged between the car guide rail 12 and the weight guide rail 22. Both ends of the support beam 24 are fastened to these guide rails by brackets 31, respectively. The worker works by utilizing a clearance between a ceiling 2a of the elevator shaft 2 and the handrail 30 of the car 4 in the vertical direction while the car 4 is stopped at a position shown in FIG. 3A. FIG. 3B shows a state in which the car 4 is stopped at its uppermost position. The elevator 1 according to the present embodiment has a constitution in which an overhead dimension is decreased. The overhead dimension is a distance from the top wall of the car 4 to the ceiling 2a of the elevator shaft 2, when the car 4 is completely raised in the elevator shaft 2.

Moreover, as shown in FIGS. 1 and 4, a sheave beam 32 is horizontally bridged between the car guide rail 12 and the weight guide rail 22. The sheave beam 32 is one example of a sheave support which holds the deflector sheaves 33, 34 in the side region A2 between the car guide rail 12 provided in the side region A2 and the weight guide rail 22 provided close to the side region A2. As shown in FIG. 4, the sheave beam 32 supports the first deflector sheave 33 disposed close to the car guide rail 12 and the second deflector sheave 34 disposed close to the weight guide rail 22 at an equal height by brackets and the like. As shown in FIG. 2, the deflector sheaves 33, 34 have rotational planes arranged in parallel with the lateral inside wall 29 of the elevator shaft 2. The first deflector sheave 33 and the second deflector sheave 34 freely rotate around rotation shafts extending horizontally in parallel with the back wall 18 of the car 4. The first deflector sheave 33 and the second deflector sheave 34 guide the main ropes 25 from the traction sheave 26 to the under-car sheaves 14, 15. The rotation shafts of the deflector sheaves 33, 34 are parallel to each other.

FIG. 4 is a side view of a region extending from the traction machine 3 to the under-car sheave 14 and including the deflector sheaves 33, 34, when the left lateral inside wall 29 is seen from the center of the elevator shaft 2. The diametric dimension of the first deflector sheave 33 is equal to that of the second deflector sheave 34. The rotation centers of the deflector sheaves 33, 34 are held at an equal height in the vertical direction of the elevator shaft 2. Moreover, the deflector sheaves 33, 34 are supported by the sheave beam 32 so as to freely rotate via a support shaft. The deflector sheaves 33, 34 are disposed so that the side surfaces of the deflector sheaves 33, 34 facing the left lateral inside wall 29 of the elevator shaft 2 are disposed on the same plane parallel to the lateral inside wall 29 with respect to the side surface of the driving unit 27 facing the left lateral inside wall 29 of the elevator shaft 2, when the elevator shaft 2 is seen from the upside in the vertical direction. As shown in FIG. 4, the bases 35 are disposed at two positions on the support beam 24 along the lateral inside wall 29.

FIG. 5 shows a development of roping of the main ropes 25 of the elevator 1 on a plane. Elements in FIG. 5 having the same reference numerals as those of the above elements are the same elements. A section of the main ropes 25 suspending the car 4 have a part extending downwardly from the traction sheave 26 to the second deflector sheave 34; a part turning under the second deflector sheave 34 and extending upwardly around the first deflector sheave 33; a part turning upwardly around the first deflector sheave 33 and extending downwardly to the under-car sheave 14 along the left side wall 16 of the car 4; a part extending horizontally between the pair of under-car sheaves 14 and 15; a part extending upwardly from the downside of the under-car sheave 15 along the right side wall 17 of the car 4; and a part fastened to a hitch 36 provided at the top of the car guide rail 13.

A section of the main ropes 25 suspending the balance weight 19 have a part extending downwardly from the traction sheave 26 to the weight sheave 20, a part extending horizontally between the pair of weight sheaves 20 and 21 of the balance weight 19, and a part turning under the weight sheave 21 and extending upwardly to be fastened to a hitch 37.

In the elevator 1 of the present embodiment having the above constitution, the control unit 28 performs calculation for determining a target floor based on information of a call and a car position after it start the operation of the car 4, and output a signal for commanding a rotation amount to the traction machine 3. The traction machine 3 rotates the traction sheave 26 to move the car 4 and the balance weight 19 suspended by the main ropes 25.

On the car 4 side of the main ropes 25, a speed ratio between a running speed at the section of the main ropes 25 extending downwardly from the traction sheave 26 to the car 4 via the deflector sheaves 33, 34 and a running speed of the car 4 is 2:1. Moreover, also on the balance weight 19 side of the main ropes 25, a speed ratio between a running speed at the section of the main ropes 25 extending downwardly from the traction sheave 26 to the balance weight 19 and a running speed of the balance weight 19 is 2:1. In the elevator 1, the car 4 and the balance weight 19 are suspended by so-called “two to one roping (2:1 roping)”. Therefore, the traction machine 3 in the elevator 1 decreases an output torque necessary for the driving unit 27 compared with an output torque in the case of suspension by so-called “one to one roping (1:1 roping)”. In consequence, a motor, which is so-called “small-radius long-length motor” having an axis direction dimension larger than a diametric dimension, is employed for the driving unit 27 of the traction machine to operate the car 4 having the same maximum load, may be employed in the elevator 1.

Moreover, this elevator 1 has no machine room on the elevator shaft 2. Therefore, an occupying volume for installing the elevator taken up by a building capacity will decrease when the elevator 1 is employed. The height of a building will also decrease as much as that of the machine room. Hence, a construction cost required for installing the machine room may be saved, and a cost related to neighborhood right of sunshine may also be saved.

In the elevator 1, the top of the handrail 30 on the car 4 does not interfere with the lower portion of the traction machine 3 even when the car 4 rises right under the ceiling 2a of the elevator shaft 2 as shown in FIG. 3B. A large operation stroke of the car 4 is secured with respect to the limited overall length of the elevator shaft.

The traction machine 3 is installed so that the output shaft of the traction machine is parallel to the left lateral inside wall 29 in the elevator 1. Therefore, the planar dimension of the elevator shaft 2 of the elevator 1 is set to be smaller than that of an elevator shaft of a conventional elevator without decreasing the work area surrounded by the handrail 30.

A part of the driving unit 27 overlaps with the car 4 when this elevator 1 is seen from the upside of the elevator shaft 2 in the vertical direction. Therefore, the planar dimension of the elevator shaft 2 is decreased as compared with a case where the conventional elevator is installed in the elevator shaft having a height equal to the height of the elevator shaft 2. According to a conventional technology, the driving unit is installed in a side region between the side wall 16 of the car 4 and the lateral inside wall 29 of the elevator shaft 2 when a driving unit which outputs a rotation driving force equal to that of the traction machine 3 is disposed in the elevator shaft having a height equal to that of the elevator shaft 2. Therefore, the planar dimension of the elevator shaft increases as much as the dimension of the traction machine in a lateral width direction. On the other hand, a part of the traction machine 3 is overhung above the car 4 in the elevator 1. Hence the planar dimension of the elevator shaft necessary for installing the traction machine 3 having the equivalent rotation driving force is set to be smaller than that of the conventional elevator shaft. That is, an available floor area in each floor is expanded, since the occupying floor area of the elevator 1 in each floor of the building is decreased.

The long shaft motor is used for the driving unit 27 of the traction machine 3 in the above embodiment. The overall height of the traction machine 3 is small. Therefore the support beam 24 carrying the traction machine 3 is set at a position higher than that in conventional elevators. Even if the traction machine 3 overlaps with the car 4 in a plane projected in the vertical direction, the height of the elevator shaft 2 is decreased in the design of the elevator 1. Moreover, the elevator 1 is installed without being influenced by the limited height of the elevator shaft in a case where the elevator is installed in a building already provided with the elevator shaft as in a renewal construction or the like.

The thickness of a traction sheave of a so-called “flat motor” having the size of a radius direction which is larger than an axial length is smaller than that of the traction sheave 26 of the long shaft motor. The diameter of the traction sheave of the flat motor is larger than that of the traction sheave of the long shaft motor. When this long shaft motor is employed for the drive unit of the traction machine 3, advantages are obtained as follows. First, since a margin is made for setting the installation height of the traction machine 3 with respect to the height of the elevator shaft, a margin is imparted to the operation stroke of the car 4. Secondly, the present invention contributes to the decrease of the planar dimension of the elevator shaft necessary for installing the traction machine having the equivalent rotation driving force as compared with the conventional elevators. Thirdly, even if the planar dimension of the elevator shaft is smaller than that of the conventional elevator shaft, the working area surrounded by the handrail 30 still maintains the size as same as conventional elevators.

Moreover, an output shaft H of the traction machine 3 is horizontally held in a plane parallel to the left lateral inside wall 29 of the elevator shaft 2. Therefore, the traction machine 3 does not noticeably project on the central side of the elevator shaft 2. A sufficiently large work area on the car 4 is secured when the handrail 30 on the car 4 is disposed close to the side wall 16 so that the handrail does not overlap with the traction machine 3 in the plane projected in the vertical direction.

Furthermore, when the elevator shaft 2 of the elevator 1 of the present embodiment is seen from the upside, as shown in FIG. 2, the side surface of the traction machine 3 facing the elevator shaft 2 is disposed in the same plane as that of the side surfaces of the deflector sheaves 33, 34 facing the elevator shaft 2. The traction machine 3 and the deflector sheaves 33, 34 are disposed with a less clearance along the left lateral inside wall 29 of the elevator shaft 2.

If the output shaft H of the traction machine 3 is disposed in a plane obliquely crossing the side wall 16 of the car 4 and the lateral inside wall 29 of the elevator shaft 2, the work area is not secured sufficiently on the car 4 because the handrail 30 is installed on the car 4 so that the handrail does not overlap with the traction machine 3 in the horizontal projection plane projected in the vertical direction. The elevator shaft 2 may be extend in the height direction in above case to dispose the traction machine 3 at a position overlapping with the handrail 30 on the car in the horizontal projection plane. The traction machine 3 in the elevator 1 of the present embodiment is installed on the support beam 24, and their projected areas overlap with each other in the horizontal projection plane, hence a space utilization ratio in the elevator shaft 2 is satisfactory.

Moreover, the deflector sheaves 33, 34 are arranged in the side region A2 between the side wall 16 of the car 4 and the lateral inside wall 29 of the elevator shaft 2. The sheave beam 32 as one aspect of a sheave support is placed at an intermediate height between the height of the traction sheave 26 and the height of the under-car sheaves 14, 15 of the car 4 moved to the uppermost position. Therefore the car 4 rises as high as the deflector sheaves 33, 34. This contributes to the decrease of the height dimension of the elevator shaft 2.

It is possible to secure both a distance from the under-car sheave 14 to the first deflector sheave 33 and a distance from the traction sheave 26 to the second deflector sheave 34, respectively. Therefore, a torsion angle per unit length of the main ropes 25 is decreased when the direction of the winding plane of the main ropes 25 is changed, whereby a dynamic load added to the main ropes 25 or each sheave decreases.

The direction of the winding plane of the main ropes 25 is changed twice between the hitch 36 and the hitch 37. A first section changing the direction of the winding plane is provided between the traction sheave 26 and the second deflector sheave 34, and a second section changing the direction of the winding plane is provided between the under-car sheave 14 and the first deflector sheave 33. The plurality of main ropes 25 are wound around the outer peripheral surface of each sheave and in parallel with one another. Therefore, the direction of the arrangement of the plurality of main ropes 25 is changed as if the main ropes were entirely twisted when the direction of the winding plane is changed. When the angle changing the winding plane is called the helix angle, the helix angle per unit length of the main ropes 25 is preferably small.

The main ropes 25 in this embodiment is changed a direction of the winding plane in the first and second sections as described above, and each of the helix angles is 90°. Since the distance between the traction sheave 26 and the second deflector sheave 34 is constant in the first section, the helix angle per unit length of the main ropes 25 is constant. Therefore, physical conditions generated between the main ropes 25 in the case of the changing the direction of the winding plane, such as a difference of tensile forces between the main ropes 25, a difference of characteristic frequencies between the main ropes 25, and the like, is constant. In consequence, it is easy to design the roping in the first section.

Moreover, since the car 4 moves, the distance between the under-car sheave 14 and the first deflector sheave 33 varies in the second section. Therefore, the helix angle per unit length of the main ropes 25 in the second section varies in accordance with the position of the car. Even in this case, since the car 4 has a sufficient height, the distance between the under-car sheave 14 and the first deflector sheave 33 is kept to be constant or more. That is, the distance between the under-car sheave 14 and the first deflector sheave 33 is set to decrease the helix angle per unit length of the main ropes 25 in the second section. Consequently, the first deflector sheave 33 and the second deflector sheave 34 are disposed at the intermediate height between the traction sheave 26 and the under-car sheave 14 when the car 4 is stopped at the uppermost position in this embodiment so that the helix angle per unit length of the main ropes 25 in the second section is smaller than that per unit length of the main ropes 25 in the first section.

In the above embodiment, the rotation shafts of the first deflector sheave 33 and the second deflector sheave 34 are parallel, and the rotation centers of the first deflector sheave 33 and second deflector sheave 34 are held at an equal height in the height direction of the elevator shaft 2. The arrangement of the deflector sheaves 33, 34 can variously be modified.

(First Modification)

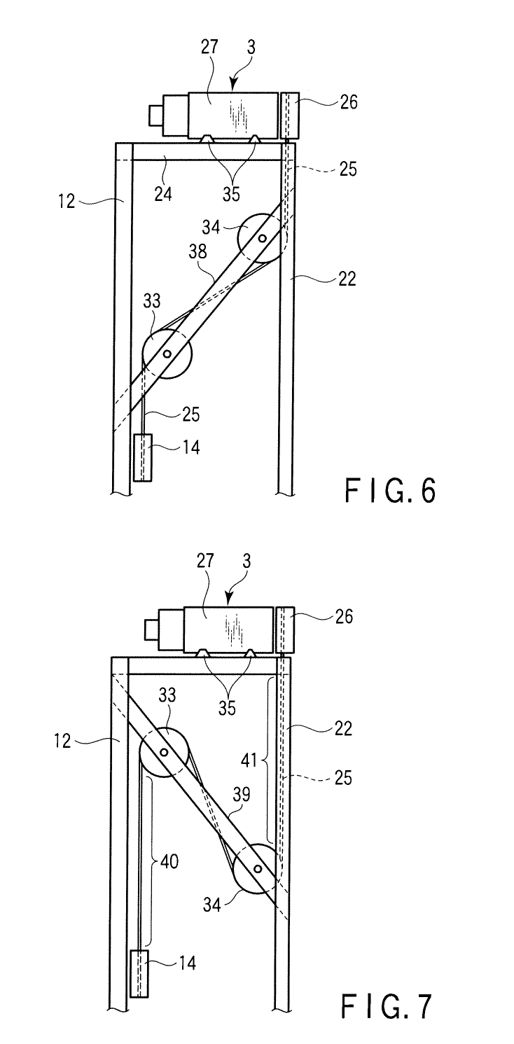

A first modification of the elevator 1 of the embodiment of the present invention is shown in FIG. 6. This elevator is different from another elevator in the layout of deflector sheaves 33, 34. FIG. 6 shows a side view of the deflector sheaves 33, 34 and their peripherals in a case where the lateral inside wall 29 is seen from the center of the elevator shaft 2. The same reference numerals in FIG. 6 as the above reference numerals indicate the same constituent elements as those denoted with the same reference numerals in the other drawings. A sheave beam 38 is one aspect of a sheave support. Both ends of the sheave beam 38 are attached to a car guide rail 12 and a weight guide rail 22. The sheave beam 38 supports the deflector sheaves 33, 34 via a bearing.

The sheave beam 38 is disposed aslant relative to the center line of each of the car guide rail 12 and the weight guide rail 22, when the left lateral inner wall 29 of the elevator shaft 2 is seen from the center of the elevator shaft 2 at a visual line in FIG. 6. The sheave beam 38 is bridged between the car guide rail 12 and the weight guide rail 22 in a state in which the longitudinal direction of the sheave beam 38 is tilted from a horizontal state. Specifically, the sheave beam 38 is attached to the car guide rail 12 at an angle smaller than 90°, when the top angle with respect to the car guide rail 12 is defined as 0°. In other words, the sheave beam 38 is bridged aslant to descent from a weight guide rail 22 side to a car guide rail 12 side.

The installation height of the first deflector sheave 33 is different from that of the second deflector sheave 34. In the first modification, the first deflector sheave 33 is installed at a position lower than that of the second deflector sheave 34. Since the installation heights of the deflector sheaves 33, 34 are varied to avoid so-called “S-bend” in which the main ropes 25 are bent in both directions in a short section in the same winding plane, a distance between the deflector sheaves 33 and 34 is increased. The fatigue of the main ropes 25 due to the S-bend is suppressed. Therefore the durability year of the main ropes 25 is lengthened.

Here, the definition of the S-bend of the main ropes 25 is that a safety ratio Sf described in, for example, “EN81:Part2:1987 Appendix N” of European Norm standards is in a range of determined values. In the case of the arrangement of the deflector sheaves 33, 34 in the elevator 1 of the first modification, a distance between two contacts of the main ropes 25 with the deflector sheaves 33, 34 is twenty times or more the diameter of each of the main ropes 25. Since the main ropes 25 do not apply to the definition of the S-bend, the safety ratio required for the main ropes 25 is set to a small ratio. That is, the number of the main ropes 25 necessary for supporting a load added to a car 4 in the elevator 1 of the first modification may be reduced a number smaller than that of the main ropes 25 necessary for a case where the main ropes 25 including an S-bend state support the same load.

In a case where the main ropes 25 wound between two sheaves have the S-bend state, the suspension strength of the main ropes 25 has to be increased as compared with a case where any S-bend state is not included. Examples of a countermeasure in this case includes (1) the increase of the number of the main ropes 25, (2) the increase of the diameter of each of the main ropes 25, (3) the increase of the outer diameter of the sheave and (4) the increase of the distance between the contacts. According to the elevator of the first modification, the sheave beam 38 is disposed aslant relative to a horizontal line, whereby the distance between the contacts of the deflector sheaves 33, 34 with the main ropes 25 is lengthened to prevent the S-bend of the main ropes 25. In consequence, the number of the main ropes 25 is decreased.

(Second Modification)

A second modification of the elevator 1 of the embodiment of the present invention is shown in FIG. 7. This elevator is different from another elevator in the layout of deflector sheaves 33, 34. FIG. 7 shows a side view of the deflector sheaves 33, 34 and their peripherals in a case where the lateral inside wall 29 is seen from the center of the elevator shaft 2. The same reference numerals in FIG. 7 as the above reference numerals indicate the same constituent elements as those denoted with the same reference numerals in the other drawings. A sheave beam 39 is one aspect of a sheave support, and is tilted so that the end of the sheave beam on a car guide rail 12 side becomes higher than the opposite end of the sheave beam on a weight guide rail 22 side. Therefore, the first deflector sheave 33 and second deflector sheave 34 supported by the sheave beam 39 are disposed at different heights, respectively. The first deflector sheave 33 is disposed higher than the second deflector sheave 34.

Since the first deflector sheave 33 on an under-car sheave 14 side is arranged at a position higher above the second deflector sheave 34 on a traction sheave 26 side, a distance from the under-car sheave 14 to the first deflector sheave 33 and a distance from the traction sheave 26 to the second deflector sheave 34 is lengthened. In a section 40 of main ropes 25 extending between the first deflector sheave 33 and the under-car sheave 14 and a section 41 of the main ropes 25 extending between the traction sheave 26 and the second deflector sheave 34, the direction of a winding plane of the main ropes 25 is twisted as much as 90°. In comparison of FIGS. 4, 6 with FIG. 7, the section 40 or 41 of the main ropes 25 shown in FIG. 7 is longer than the section where the main ropes 25 are twisted as much as 90° in FIG. 4 or 6.

According to the elevator of the second modification, it decreases a helix angle per unit length of the main ropes 25 in the section where the main ropes are twisted by changing the direction of the winding plane of the main ropes 25. In consequence, a dynamic load added to the main ropes 25 or the deflector sheaves 33, 34 decreases. Therefore, it is possible to prevent the damage of the main ropes 25 due to the changing of the direction of the winding plane of the main ropes 25 in a short section.

(Third Modification)

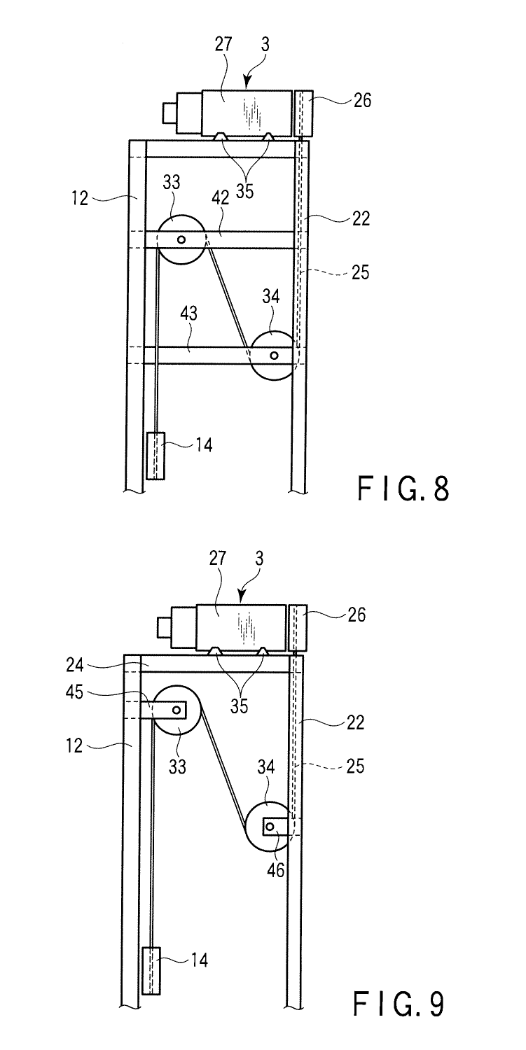

A third modification of the elevator 1 of the embodiment of the present invention is shown in FIG. 8. This elevator is different from another elevator in the constitution of a sheave support for supporting deflector sheaves 33, 34. FIG. 8 shows a side view of the deflector sheaves 33, 34 and their peripherals in a case where the lateral inside wall 29 is seen from the center of the elevator shaft 2. The same reference numerals in FIG. 8 as the above reference numerals indicate the same constituent elements as those denoted with the same reference numerals in the other drawings. Sheave beams 42, 43 are one aspect of the sheave support, and each of the sheave beams is bridged between a car guide rail 12 and a weight guide rail 22. Both the sheave beams 42, 43 horizontally extend. The higher sheave beam 42 is installed at a position higher above the lower sheave beam 43. The first deflector sheave 33 is held by the higher sheave beam 42 via a bearing. The second deflector sheave 34 is held by the lower sheave beam 43 via a bearing.

Since the two deflector sheaves 33, 34 are disposed at the different heights, a distance between the deflector sheaves 33 and 34 lengthens. In the elevator of the third modification, a distance between contacts of main ropes 25 with respect to the deflector sheaves 33, 34 is twenty times or more the diameter of each of the main ropes 25. Therefore, the main ropes 25 wound around the deflector sheaves 33, 34 deviate from a state defined as S-bend. In consequence, a safety ratio required for the main ropes 25 is set to a small ratio. That is, in the same manner as in the first and second modifications, the number of the main ropes 25 necessary for supporting a load added to a car 4 in the elevator 1 is reduced as compared with that of the main ropes 25 necessary for a case where the main ropes 25 including the S-bend state support the same load.

(Fourth Modification)

A fourth modification of the elevator 1 of the embodiment of the present invention is shown in FIG. 9. This elevator is different from another elevator in the constitution of the sheave support for supporting deflector sheaves 33, 34. FIG. 9 shows a side view of the deflector sheaves 33, 34 and their peripherals in a case where a lateral inside wall 29 is seen from the center of an elevator shaft 2. The same reference numerals in FIG. 9 as the above reference numerals indicate the same constituent elements as those denoted with the same reference numerals in the other drawings.

In the modifications shown in FIGS. 6 to 8, the sheave beams 38, 39, 42 and 43 are bridged as the sheave supports between the car guide rail 12 and the weight guide rail 22, and the deflector sheaves 33, 34 are held by the sheave beams 38, 39, 42 and 43. In the fourth modification shown in FIG. 9, instead of the sheave beams 38, 39, 42 and 43, sheave brackets 45, 46 support the deflector sheaves 33, 34. The deflector sheaves 33, 34 are axially supported by the sheave brackets 45, 46 each provided as a cantilever.

The first sheave bracket 45 is disposed horizontally in a longitudinal direction, and extends along a plane parallel to the lateral inside wall 29 in a side region A2. The first sheave bracket 45 extends rearwardly from the car guide rail 12 as the cantilever, and supports the first deflector sheave 33 at the tip. The second sheave bracket 46 is similarly disposed horizontally in the longitudinal direction, and extends along the plane parallel to the lateral inside wall 29 in the side region A2. The second sheave bracket 46 extends forwardly from the weight guide rail 22 as the cantilever, and supports the second deflector sheave 34 at the tip.

In this manner, a support structure of the deflector sheaves 33, 34 in the fourth modification is a structure in which the sheave bracket 45 or 46 projects rearwardly or forwardly from each rail along the lateral inside wall 29 in the side region A2. The deflector sheaves 33, 34 are freely rotatably supported by the sheave brackets 45, 46 as the corresponding cantilevers. Since the first sheave bracket 45 is disposed higher above the second sheave bracket 46, a sheave distance between the deflector sheaves 33 and 34 lengthens.

According to the elevator of the fourth modification, in the same manner as in the first to third modifications, main ropes 25 of a section from a traction sheave 26 to an under-car sheave 14 via the second deflector sheave 34 and the first deflector sheave 33 deviate from the definition of S-bend. Therefore, a safety ratio required for the main ropes 25 is set to a small ratio. That is, the number of the main ropes 25 is reduced in the same manner as in the first to third modifications.

(Fifth Modification)

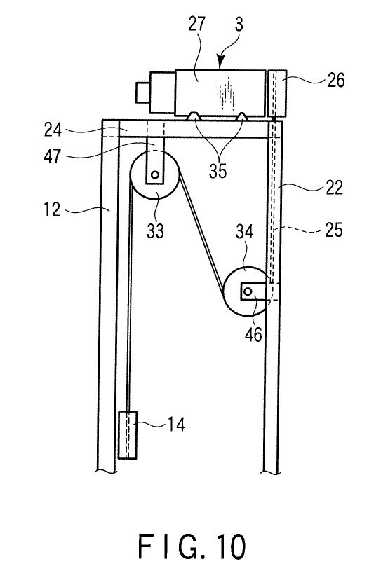

A fifth modification of the elevator 1 of the embodiment of the present invention is shown in FIG. 10. This elevator is different from another aspect in the constitution of a sheave support for supporting deflector sheaves 33, 34. FIG. 10 shows a side view of the deflector sheaves 33, 34 and their peripherals in a case where the lateral inside wall 29 is seen from the center of the elevator shaft 2. The same reference numerals in FIG. 10 as the above reference numerals indicate the same constituent elements as those denoted with the same reference numerals in the other drawings.

As shown in FIG. 10, the fifth modification comprises a third sheave bracket 47 which functions as a sheave support for supporting the first deflector sheave 33 and a fourth sheave bracket 46 which functions as a sheave support for supporting the second deflector sheave 34. It is to be noted that the fourth sheave bracket 46 is the same as the second sheave bracket 46 of the fourth modification.

The third sheave bracket 47 does not extend from a car guide rail 12 but extends downwardly from a support beam 24 on which a traction machine 3 is mounted. The third sheave bracket 47 is supported vertically in a longitudinal direction. The third sheave bracket 47 extends downwardly from the support beam 24 along a plane parallel to the lateral inside wall 29 in a side region A2, and the bracket as a cantilever supports the first deflector sheave 33 at a tip. The third sheave bracket 47 projects downwardly from the support beam 24. The first deflector sheave 33 is freely rotatably supported via a bearing at the tip of the third sheave bracket 47 provided as the cantilever from the support beam 24.

According to the elevator of the fifth modification, since a distance between the deflector sheaves 33 and 34 is set to a long distance, a safety ratio required for main ropes 25 is set to a small ratio in the same manner as in the first to fourth modifications. Hence, the number of the main ropes 25 is reduced in the same manner as in the first to fourth modifications.

According to the elevator 1 of the embodiment of the present invention and the elevators of the first to fifth modifications, the planar dimension of the elevator shaft 2 decreases. Moreover, a sufficiently large work area is secured even in a case where the handrail 30 installed on the car 4 is disposed closer to the center of the elevator shaft 2 from the traction machine 3 so that the handrail 30 does not overlap with the traction machine 3 on the plane projected in the vertical direction.

There is a demand for the decrease of the occupying ratio of the elevator shaft of the elevator with respect to the floor area for effective utilization of the floor area in the building. There is also a demand for the increase of the occupying floor area of the car 4 with respect to the installation floor area of the elevator shaft 2. As a result of investigation for simultaneously meeting these demands, the inner space of the elevator shaft 2 is efficiently utilized while decreasing the planar dimension of the elevator shaft to acquire the occupying floor area of the car 4 according to the elevator 1 of the embodiment of the present invention. Moreover, it is possible to increase the work area surrounded by the handrail and prepared on the car 4 to be utilized for maintenance check or the like.

According to the elevator of the present invention, the car 4 is disposed so that the side wall 16 of the car 4 is positioned close to the lateral inside wall 29 of the elevator shaft 2, because (1) the traction machine 3 prolonged along the center line of the output shaft of the driving unit 27 has a center line thereof disposed along the lateral inside wall 29 of the elevator shaft 2, (2) the traction machine 3 is disposed so that a part of the projected area of the traction machine 3 overlaps with the projected area of the car 4 on the horizontal projection plane projected in the vertical direction, and (3) the two deflector sheaves 33, 34 have the rotational planes arranged in parallel with the lateral inside wall 29.

Moreover, in the elevator 1, since the side surface of the traction machine 3 facing the lateral inside wall 29 of the elevator shaft 2 is disposed in the same plane as that of the side surfaces of the deflector sheaves 33, 34 facing the lateral inside wall 29 of the elevator shaft 2 on the horizontal projection plane, the main ropes 25 is arranged between the outer wall of the car and the inside wall of the elevator shaft without increasing the planar dimension of the elevator shaft.

If the overlapping ratio of the projected area of the traction machine 3 with that of the car 4 is increased in the horizontal projection plane, the traction machine 3 is disposed inwardly in the elevator shaft 2. Therefore, the traction machine 3 may overlap with the handrail 30. In the elevator 1 of the present embodiment, since the rotation shaft of the driving unit 27 is disposed along the lateral inside wall 29 of the elevator shaft 2 so that the traction machine 3 is not disposed closer to the center of the elevator shaft 2, the space on the car 4 usable as the work area is enlarged.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An elevator comprising:
a car moving in an elevator shaft;
a balance weight moving along a back region between a back wall of the car and the rear inside wall of the elevator shaft;
a traction sheave having a rotational plane arranged in parallel with the back wall of the car in the back region of the uppermost portion of the elevator shaft;
a plurality of deflector sheaves having rotational planes arranged in parallel with a lateral inside wall of the elevator shaft in a side region between one side wall of the car and the lateral inside wall of the elevator shaft corresponding to the side wall of the car;
a driving unit installed on the rotation center line of the traction sheave to drive the traction sheave and having at least a portion disposed in the side region; and
a plurality of main ropes passed under the car and changed the direction of a winding plane of the main ropes between at least the traction sheave and the deflector sheave.

2. The elevator according to claim 1, wherein
the driving unit has a dimension in the radius direction of an output shaft of a torque smaller than a dimension in a direction along the center line of the output shaft.

3. The elevator according to claim 1, wherein
the driving unit includes a side surface facing the lateral inside wall of the elevator shaft; and
the deflector sheaves include side surfaces facing the lateral inside wall of the elevator shaft,
wherein
the side surface of the driving unit and the side surfaces of the deflector sheaves are disposed in the same plane parallel to the lateral inner wall.

4. The elevator according to claim 1, further comprising:
a pair of car guide rails provided in the elevator shaft and arranged on both sides of the car;
a pair of weight guide rails provided in the elevator shaft and arranged on both sides of the balance weight;
a support beam bridged in the side region between the top of the car guide rail provided in the side region and the top of the weight guide rail provided closer to the side region; and
a base fastened on the support beam and on which the driving unit is settled.

5. The elevator according to claim 1, further comprising:
a pair of car guide rails provided in the elevator shaft and arranged on both sides of the car;
a pair of weight guide rails provided in the elevator shaft and arranged on both sides of the balance weight; and
a sheave support holding the deflector sheaves in the side region between the car guide rail provided in the side region and the weight guide rail disposed closer to the side region.

6. The elevator according to claim 5, wherein
the sheave support comprises a sheave beam bridged aslant between the car guide rail disposed in the side region and the weight guide rail disposed closer to the side region.

7. The elevator according to claim 5, wherein
the sheave support comprises a sheave beam bridged to descend aslant from the side of the car guide rail disposed in the side region to the side of the weight guide rail disposed closer to the side region, and
the deflector sheaves comprise a first deflector sheave disposed at a higher position closer to the car guide rail and a second deflector sheave disposed at a lower position closer to the weight guide rail.

8. The elevator according to claim 5, wherein
the sheave support comprises a higher sheave beam and a lower sheave beam bridged at different heights between the car guide rail provided in the side region and the weight guide rail provided closer to the side region, and
the deflector sheaves comprise a first deflector sheave supported closer to the car guide rail by the higher sheave beam and a second deflector sheave supported closer to the weight guide rail by the lower sheave beam.

9. The elevator according to claim 5, wherein
the sheave support comprises: a first sheave bracket extending as a cantilever from the car guide rail provided in the side region; and a second sheave bracket extending as a cantilever from the weight guide rail provided closer to the side region, and
the deflector sheaves comprise: a first deflector sheave supported by the first sheave bracket; and a second deflector sheave supported by the second sheave bracket.

10. The elevator according to claim 5, further comprising:
a support beam bridged in the side region between the car guide rail disposed in the side region and the weight guide rail disposed closer to the side region,
wherein the sheave support comprises: a third sheave bracket extending as a cantilever downwardly from the support beam; and a fourth sheave bracket extending as a cantilever along the side region from the weight guide rail provided closer to the side region, and
the deflector sheaves comprise: a first deflector sheave supported by the third sheave bracket; and a second deflector sheave supported by the fourth sheave bracket.
